(19) United States
(12) Patent Application Publication
(10) Pub. No.: US 2025/0257581 A1
(43) Pub. Date: Aug. 14, 2025

(54) BINDING MACHINE

(71) Applicant: Max Co., Ltd., Tokyo (JP)

(72) Inventors: Makoto Kosuge, Tokyo (JP); Naoki Kamiya, Tokyo (JP); Terufumi Hamano, Tokyo (JP)

(21) Appl. No.: 18/983,950

(22) Filed: Dec. 17, 2024

(30) Foreign Application Priority Data
Feb. 9, 2024 (JP) 2024-018379

(51) Int. Cl. E04G 21/12; B25B 25/00

(52) U.S. Cl. CPC E04G 21/123; B25B 25/00

(57) ABSTRACT

A binding machine configured to wind a wire around a to-be-bound object, includes: a main body part; an arm part attached to the main body part and configured to curl the wire; a curl guide part attached to the main body part and configured to guide the wire curled by the arm part to a binding portion; and a regulating member configured to regulate relative displacement between the arm part and the curl guide part.

### CROSS-REFERENCE TO RELATED APPLICATIONS

This application is based on and claims priority under 35 USC § 119 from Japanese Patent Application No. 2024-018379 filed on Feb. 9, 2024, the contents of which are incorporated herein by reference.

### TECHNICAL FIELD

The present disclosure relates to a binding machine for binding a to-be-bound object, such as a reinforcing bar, with a wire.

### BACKGROUND ART

For concrete buildings, reinforcing bars are used so as to improve strength. The reinforcing bars are bound with wires so that the reinforcing bars do not deviate from predetermined positions during concrete placement.

In the related art, suggested is a binding machine referred to as a reinforcing bar binding machine configured to wind a wire on two or more reinforcing bars and to twist the wire wound on the reinforcing bars, thereby binding the two or more reinforcing bars with the wire.

When a diameter of the reinforcing bars to be bound with the wire increases, it is necessary to increase a diameter of the feeding path of the wires that are wound in an annular shape around the reinforcing bars. Therefore, a reinforcing bar binding machine is suggested which can reliably guide the wire to the binding portion even when the diameter of the feeding path of the wire, which is wound in an annular shape, increases (for example, see Patent Literature 1).
Patent Literature 1: Japanese Patent No. 7302302B

In order to increase the diameter of the feeding path of the wire, which becomes an annular shape, it is necessary to enlarge a diameter of a curl forming portion that curls the wire, compared to the related art. However, in order to increase the diameter and maintain the stability of the binding, a tip portion of the curl forming portion becomes longer than that in the related art. However, when the length of the curl forming portion increases, the likelihood of positional misalignment between portions of the curl forming portion increases, and the force applied to the curl forming portion due to a drop or collision increases.

An object thereof is to provide a binding machine configured to be able to firmly maintain a curl forming portion.

### SUMMARY OF INVENTION

An aspect of the present disclosure is a binding machine configured to wind a wire around a to-be-bound object, including: a main body part; an arm part attached to the main body part and configured to curl the wire; a curl guide part attached to the main body part and configured to guide the wire curled by the arm part to a binding portion; and a regulating member configured to regulate relative displacement between the arm part and the curl guide part.

In addition, another aspect of the present disclosure is a binding machine configured to wind a wire around a to-be-bound object, including: a main body part; an arm part attached to the main body part and configured to curl the wire; a curl guide part attached to the main body part; and a support member configured to support at least one of the main body part, the arm part, and the curl guide part.

### BRIEF DESCRIPTION OF DRAWINGS

FIG. 1 is a side view showing an example of a reinforcing bar binding machine of the present embodiment.

FIG. 2 is a perspective view of main parts showing the example of the reinforcing bar binding machine of the present embodiment.

FIG. 3 is an internal configuration view showing the example of the reinforcing bar binding machine of the present embodiment, as seen from a side.

FIG. 4A is a side view of main parts of the example of the reinforcing bar binding machine of the present embodiment, as seen from a side.

FIG. 4B is a side view of main parts of the reinforcing bar binding machine of the present embodiment, with a tip guide part removed, as seen from a side.

FIG. 5A is a side view of main parts of the example of the reinforcing bar binding machine of the present embodiment, as seen from the other side.

FIG. 5B is a side view of main parts of the reinforcing bar binding machine of the present embodiment, with a tip guide part removed, as seen from the other side.

FIG. 6A is a perspective view showing an example of the tip guide part.

FIG. 6B is a perspective view showing the example of the tip guide part.

FIG. 7 is a side view of main parts showing another example of the reinforcing bar binding machine of the present embodiment, as seen from a side.

FIG. 8 is a side view of main parts showing still another example of the reinforcing bar binding machine of the present embodiment, as seen from a side.

FIG. 9 is a side view of main parts showing yet another example of the reinforcing bar binding machine of the present embodiment, as seen from a side.

### DESCRIPTION OF EMBODIMENTS

Hereinafter, an example of a reinforcing bar binding machine as an embodiment of the binding machine of the present disclosure will be described with reference to the drawings.

### Configuration Example of Reinforcing Bar Binding Machine of Present Embodiment

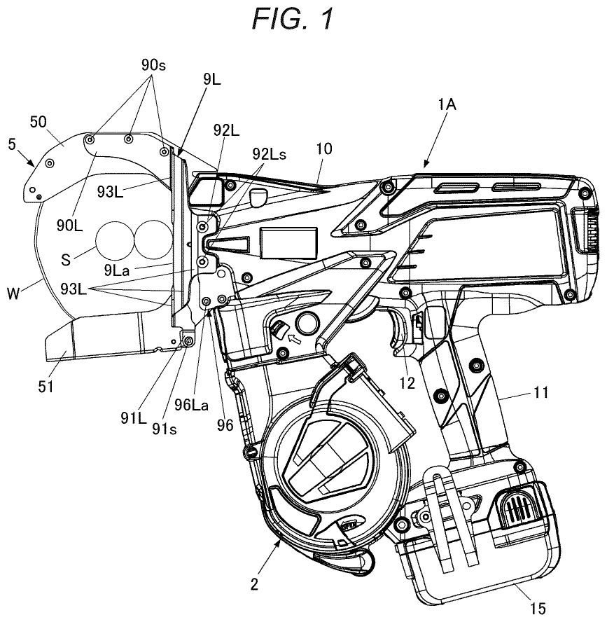

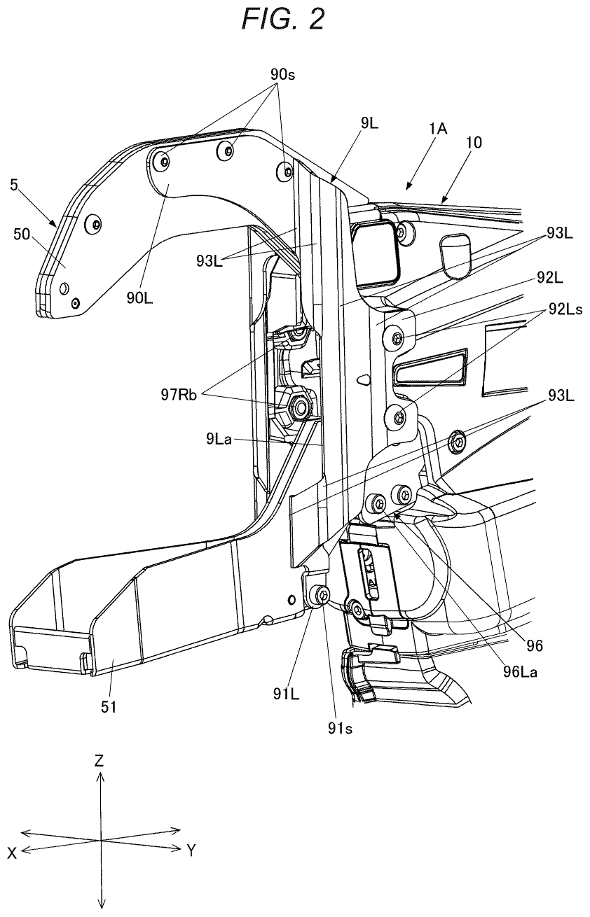

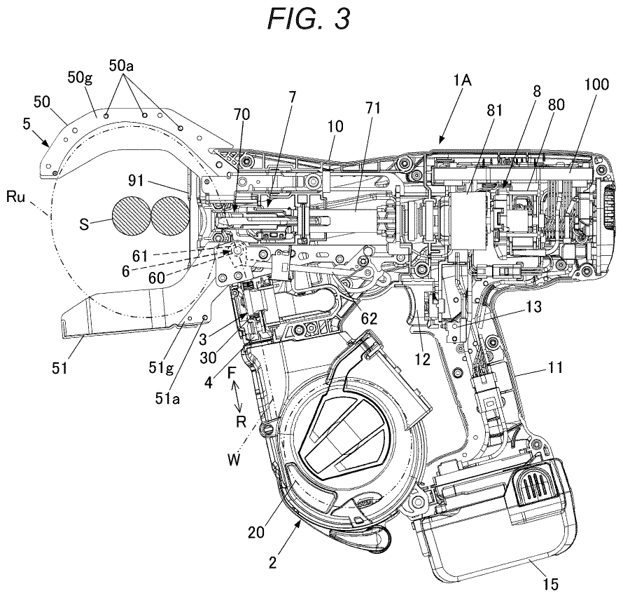

FIG. 1 is a side view showing an example of a reinforcing bar binding machine of the present embodiment, FIG. 2 is a perspective view of main parts showing the example of the reinforcing bar binding machine of the present embodiment, and FIG. 3 is an internal configuration view showing the example of the reinforcing bar binding machine of the present embodiment, as seen from a side.

A reinforcing bar binding machine 1A has such a shape that an operator grips with a hand, and includes a main body part 10 and a handle part 11. In addition, the reinforcing bar binding machine 1A feeds wires W in a forward direction indicated by arrow F, winds the wires around reinforcing bars S, which are a to-be-bound object, feeds the wires W wound around the reinforcing bars S in a reverse direction indicated by arrow R, winds the wires on the reinforcing bars S, and twists the wires W, thereby binding the reinforcing bars S with the wires W. The reinforcing bar binding machine 1A binds the reinforcing bars S with a plurality of wires W, in the present example, two wires W.

In order to implement the above-described functions, the reinforcing bar binding machine 1A includes a magazine 2 in which the wires W are accommodated, a wire feeding portion 3 that feeds the wires W, and a wire guide portion 4 that guides the wires W, which are fed by the wire feeding portion 3. In addition, the reinforcing bar binding machine 1A includes a curl forming portion 5 that forms an annular feeding path for winding the wires W, which are fed by the wire feeding portion 3, around the reinforcing bars S, and a cutting portion 6 that cuts the wires W wound on the reinforcing bars S. In addition, the reinforcing bar binding machine 1A includes a binding portion 7 that twists the wires W wound on the reinforcing bars S, and a drive portion 8A that drives the binding portion 7. In addition, the reinforcing bar binding machine 1A includes tip guide parts 9L and 9R against which the reinforcing bars S are abutted and which support the curl forming portion 5.

In the reinforcing bar binding machine 1A, an axial direction of the binding portion 7 that is driven by the drive portion 8 and rotates is indicated by arrow X, and the direction of arrow X along the axial direction of the binding portion 7 is referred to as a front-rear direction, and a side on which the curl forming portion 5 is provided is referred to as a front side. Additionally, in the reinforcing bar binding machine 1A, a direction along an extension direction of the handle part 11, among directions intersecting the axial direction of the binding portion, 7 is indicated by arrow Z, and the direction of arrow Z is referred to as an up-down direction. Additionally, in the reinforcing bar binding machine 1A, a direction intersecting the extension direction of the handle part 11, among the directions intersecting the axial direction of the binding portion 7, is indicated by arrow Y, and the direction of arrow Y is referred to as a left-right direction.

The magazine 2 is an example of an accommodation portion, and a reel 20 on which the long wire W is wound to be reeled out is rotatably and detachably accommodated therein. The wire W is an example of a consumable item. For the wire W, a wire made of a plastically deformable metal wire, a wire having a metal wire covered with a resin, or a twisted wire is used. In a configuration in which the reinforcing bars S are bound with two wires W, the two wires W are wound on the reel 20 and can be pulled out at the same time from the reel 20.

The wire feeding portion 3 includes a pair of feeding gears 30 that sandwiches and feeds the wires W. In the wire feeding portion 3, a rotating operation of a feeding motor (not shown) is transmitted to the feeding gears 30, causing the feeding gears 30 to rotate. Additionally, in the wire feeding portion 3, a rotation direction of the feeding motor (not shown) is switched between forward and reverse directions to switch a rotation direction of the feeding gears 30, thereby switching a feeding direction of the wires W between the forward and reverse directions. In the configuration where the reinforcing bars S are bound with two wires W, the wire feeding portion 3 aligns the two wires W in a radial direction of the wires W and feeds the wires.

The wire guide portion 4 is arranged on upstream and downstream sides of the feeding gears 30 with respect to the feeding direction of the wires W that are fed in the forward direction. In the configuration where the reinforcing bars S are bound with two wires W, the wire guide portion 4 aligns the two entering wires W in parallel along a direction in which the pair of feeding gears 30 is aligned and guides the same between the pair of feeding gears 30.

The curl forming portion 5 includes an arm part 50 that curls the wires W, which are fed by the wire feeding portion 3, and a curl guide part 51 that guides the wires W curled by the arm part 50 to the binding portion 7. The curl forming portion 5 curls the wires W, which are fed by the wire feeding portion 3 and pass through the arm part 50, by the arm part 50, thereby forming an annular feeding path Ru, represented by a two-dot chain line, passing through the curl guide part 51 from the arm part 50 and reaching the binding portion 7.

The arm part 50 has a groove, which has a width through which the wires W pass and is formed along a circumferential direction of the annular feeding path Ru. In the configuration where the reinforcing bars S are bound with two wires W, the arm part 50 aligns the two entering wires W in parallel in a direction in which the wires are aligned along an axial direction of the annular feeding path Ru. In addition, the arm part 50 includes a guide surface forming portion 50g that guides the wires W along a radial direction of the annular feeding path Ru. The guide surface forming portion 50g is provided on a radially outer side of the annular feeding path Ru.

The curl guide part 51 has a groove, which has a width through which the wires W pass and is formed along the circumferential direction of the annular feeding path Ru. The curl guide part 51 is configured such that an opening area of an opening on the upstream side with respect to the feeding direction of the wires W, which are fed in the forward direction, is larger than that of an opening on the downstream side, and a part of an inner surface of the opening is tapered. In the configuration where the reinforcing bars S are bound with two wires W, the curl guide part 51 aligns the two entering wires W in parallel in a direction in which the wires are aligned along the axial direction of the annular feeding path Ru. In addition, the curl guide part 51 includes a guide surface forming portion 51g that guides the wires W along the radial direction of the annular feeding path Ru. The guide surface forming portion 51g is provided on the radially outer side of the annular feeding path Ru.

The cutting portion 6 includes a fixed blade part 60, a movable blade part 61 that cuts the wires W in cooperation with the fixed blade part 60, and a transmission mechanism 62 that transmits an operation of the binding portion 7 to the movable blade part 61. The cutting portion 6 cuts the wires W by a rotating operation of the movable blade part 61 about the fixed blade part 60 as a fulcrum shaft.

The binding portion 7 includes a wire locking body 70 to which the wires W are locked, and a sleeve 71 for actuating the wire locking body 70. The drive portion 8 includes a twist motor 80 and a decelerator 81 that performs deceleration and torque amplification.

In the reinforcing bar binding machine 1A, the handle part 11 extends downward from the main body part 10. In addition, a battery 15 is detachably mounted to a lower part of the handle part 11. In addition, in the reinforcing bar binding machine 1A, the magazine 2 is provided in front of the handle part 11.

In the reinforcing bar binding machine 1A, a trigger 12 is provided on a front side of the handle part 11, and a switch 13 is provided inside the handle part 11. In the reinforcing bar binding machine 1A, a control portion 100 controls the twist motor 80 and the feeding motor (not shown), in response to a state of the switch 13 that is pressed by an operation on the trigger 12.

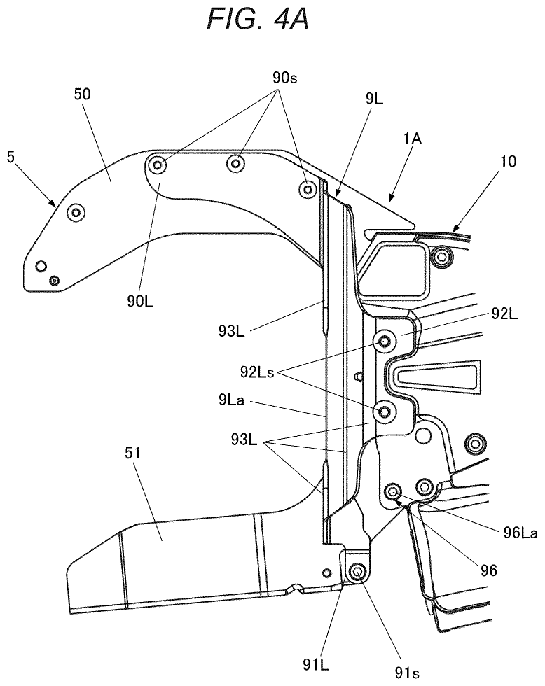

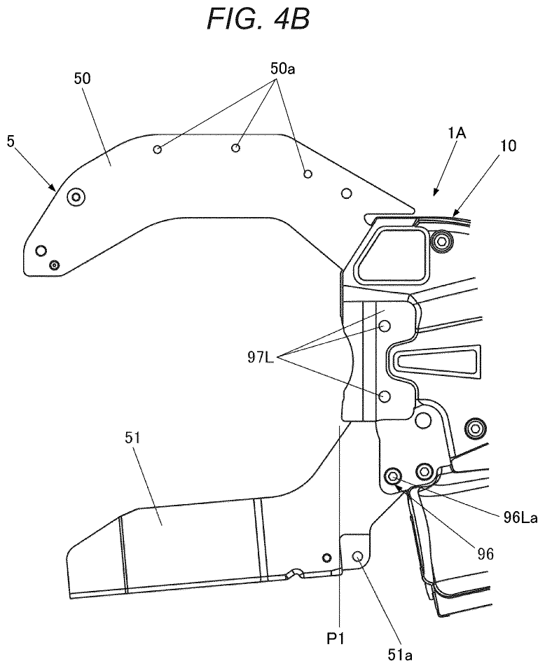

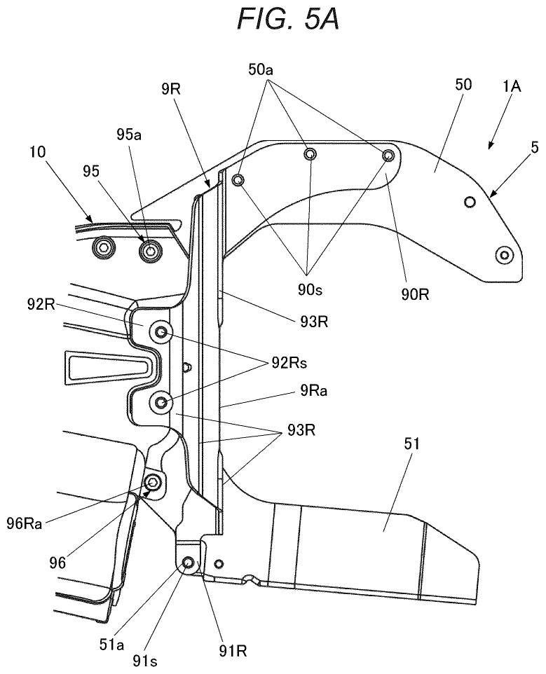

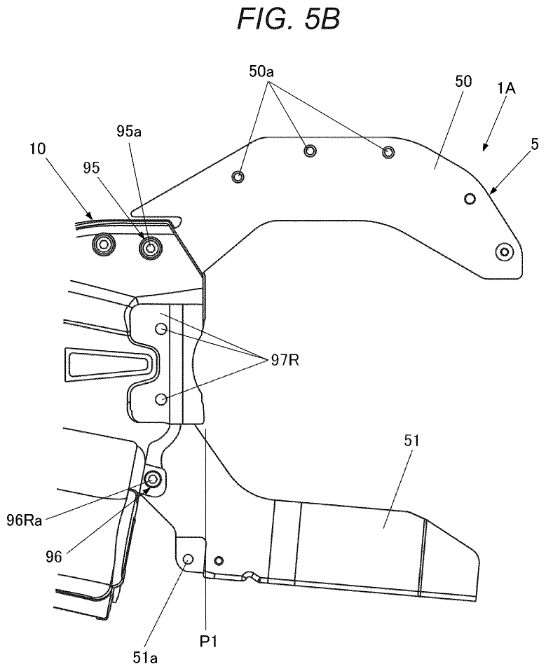

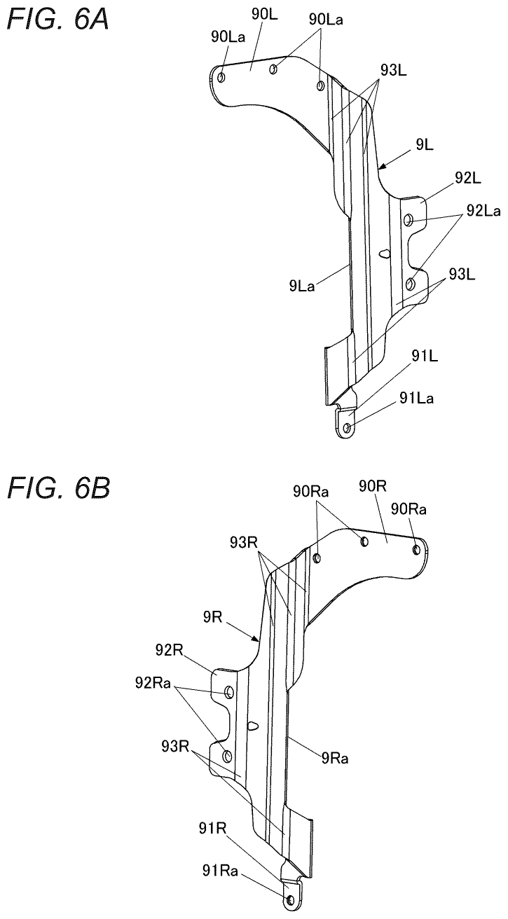

FIG. 4A is a side view of main parts of the example of the reinforcing bar binding machine of the present embodiment, as seen from a side, and FIG. 4B is a side view of main parts of the reinforcing bar binding machine of the present embodiment, with a tip guide part removed, as seen from a side. Additionally, FIG. 5A is a side view of main parts of the example of the reinforcing bar binding machine of the present embodiment, as seen from the other side, and FIG. 5B is a side view of main parts of the reinforcing bar binding machine of the present embodiment, with a tip guide part removed, as seen from the other side. Additionally, FIGS. 6A and 6B are perspective views showing an example of the tip guide part, in which FIG. 6A shows an example of the tip guide part 9L, and FIG. 6B shows an example of the tip guide part 9R.

The tip guide part 9L is an example of a regulating means (regulating member) or support member, and is provided at an end portion on the front side of the main body part 10, on one side. The tip guide part 9L includes an abutting portion 9La against which the reinforcing bars S are abutted, an arm support portion 90L supported on the arm part 50, a curl guide support portion 91L supported on the curl guide part 51, and a main body support portion 92L supported on the main body part 10.

The abutting portion 9La is provided between the arm part 50 and the curl guide part 51 and protrudes further forward than the end portion on the front side of the main body part 10.

The arm support portion 90L is an example of a first supported portion and extends forward from the abutting portion 9La along the arm part 50. The arm support portion 90L has hole portions 90La into which screws 90s are inserted. The hole portions 90La are provided at multiple locations along the extension direction of the arm support portion 90L.

The curl guide support portion 91L is an example of a first supported portion and extends forward from the abutting portion 9La along the curl guide part 51. The curl guide support portion 91L has a hole portion 91La into which a screw 91s is inserted.

The main body support portion 92L is an example of a second supported portion and connects the arm support portion 90L and the curl guide support portion 91L. The main body support portion 92L has hole portions 92La into which screws 92Ls are inserted.

The arm support portion 90L extends with the main body support portion 92L serving as a base end and tapers from the main body support portion 92L toward a tip. That is, the arm support portion 90L has a shape in which the base end is thicker than the tip. In addition, a length of the arm support portion 90L along the extension direction of the arm part 50 is configured to be shorter than that of the arm part 50. Therefore, the arm support portion 90L does not protrude from a tip of the arm part 50.

The tip guide part 9L includes bent portions 93L between the arm support portion 90L and the main body support portion 92L and between the curl guide support portion 91L and the main body support portion 92L. The bent portions 93L are configured by providing bent portions, curved portions, or the like, in which a step is formed, between the arm support portion 90L and the main body support portion 92L and between the curl guide support portion 91L and the main body support portion 92L.

The tip guide part 9R is an example of a regulating means (regulating member) or support member and is provided at the end portion on the front side of the main body part 10, on the other side. The tip guide part 9R includes an abutting portion 9Ra against which the reinforcing bars S are abutted, an arm support portion 90R supported on the arm part 50, a curl guide support portion 91R supported on the curl guide part 51, and a main body support portion 92R supported on the main body part 10.

The abutting portion 9Ra is provided between the arm part 50 and the curl guide part 51 and protrudes further forward than the end portion on the front side of the main body portion 10.

The arm support portion 90R is an example of a first supported portion and extends forward from the abutting portion 9Ra along the arm part 50. The arm support portion 90R has screw hole portions 90Ra into which the screws 90s are fastened. The screw hole portions 90Ra are provided at multiple locations along the extension direction of the arm support portion 90R, in alignment with the arrangement of the hole portions 90La.

The curl guide support portion 91R is an example of a first supported portion and extends forward from the abutting portion 9Ra along the curl guide part 51. The curl guide support portion 91R has a screw hole portion 91Ra into which the screw 91s is fastened. The screw hole portion 91Ra is provided in alignment with the arrangement of the hole portion 91La.

The main body support portion 92R is an example of a second supported portion and connects the arm support portion 90R and the curl guide support portion 91R. The main body support portion 92R has hole portions 92Ra into which screws 92Rs are inserted.

The arm support portion 90R extends with the main body support portion 92R serving as a base end and tapers from the main body support portion 92R toward a tip. That is, the arm support portion 90R has a shape in which the base end is thicker than the tip. In addition, a length of the arm support portion 90R along the extension direction of the arm part 50 is configured to be shorter than that of the arm part 50. Therefore, the arm support portion 90R does not protrude from the tip of the arm part 50.

The tip guide part 9R includes bent portions 93R between the arm support portion 90R and the main body support portion 92R and between the curl guide support portion 91R and the main body support portion 92R. The bent portions 93R are configured by providing bent portions, curved portions, or the like, in which a step is formed, between the arm support portion 90R and the main body support portion 92R and between the curl guide support portion 91R and the main body support portion 92R.

The arm part 50 has hole portions 50a into which the screws 90s are inserted. The hole portions 50a are provided at multiple locations along the extension direction of the arm part 50 in alignment with the arrangements of the hole portions 90La and the screw hole portions 90Ra. The hole portions 50a are provided on a radially outer side of the annular feeding path Ru and penetrate through the guide surface forming portion 50g. Thereby, the hole portions 50a are not exposed to the annular feeding path Ru.

The curl guide part 51 has a hole portion 51a into which the screw 91s is inserted. The hole portion 51a is provided in alignment with the arrangement of the hole portion 91La and the screw hole portion 91Ra. The hole portion 51a is provided on the radially outer side of the annular feeding path Ru and penetrates through the guide surface forming portion 51g. Thereby, the hole portion 51a is not exposed to the annular feeding path Ru.

The main body part 10 includes a main body-side arm support portion 95 by which the arm part 50 is supported and a main body-side curl guide support portion 96 by which the curl guide part 51 is supported. In addition, the main body part 10 includes a main body-side tip guide support portion 97L by which the tip guide part 9L is supported and a main body-side tip guide support portion 97R by which the tip guide part 9R is supported.

The main body-side arm support portion 95 is provided on an opposite side (upper side of the binding portion 7) to a side on which the wire feeding portion 3 and the cutting portion 6 are provided, at a position rearward along the axial direction of the binding portion 7 relative to an end portion P1 on the front side of the main body part 10. The main body-side arm support portion 95 supports the arm part 50 by screws 95a. The screw 95a is an example of a first support portion and supports the arm part 50 on the main body part 10 by being fastened to a female screw portion (not shown).

The main body-side curl guide support portion 96 is provided on the side (lower side of the binding portion 7) on which the wire feeding portion 3 and the cutting portion 6 are provided, at a position rearward along the axial direction of the binding portion 7 relative to the end portion P1 on the front side of the main body part 10. The main body-side curl guide support portion 96 supports the curl guide part 51 by screws 96La and 96Ra. The screws 96La and 96Ra are examples of a first support portion and support the curl guide part 51 on the main body part 10 by being fastened to female screw portions (not shown).

The main body-side tip guide support portion 97L is provided on one side intersecting the axial direction of the binding portion 7, at a position rearward along the axial direction of the binding portion 7 relative to the end portion P1 on the front side of the main body part 10. The main body-side tip guide support portion 97L supports the tip guide part 9L by screws 92Ls. The screw 92Ls is an example of a third support portion and supports the tip guide part 9L on the main body part 10 by being fastened to a fastened portion (not shown) provided in the main body part 10.

The main body-side tip guide support portion 97R is provided on the other side intersecting the axial direction of the binding portion 7, at a position rearward along the axial direction of the binding portion 7 relative to the end portion P1 on the front side of the main body part 10. The main body-side tip guide support portion 97R supports the tip guide part 9R by screws 92Rs. The screw 92Rs is an example of a third support portion and supports the tip guide part 9R on the main body part 10 by being fastened to a fastened portion 97Rb (see FIG. 2) provided in the main body part 10. The fastened portion 97Rb may be in the form of a nut embedded in the main body part 10.

When the tip guide part 9L is supported on the main body-side tip guide support portion 97L, the arm support portion 90L is positioned forward along the axial direction of the binding portion 7 relative to the main body-side arm support portion 95 and the screws 95a. In addition, when the tip guide part 9L is supported on the main body-side tip guide support portion 97L, the arm support portion 90L is positioned on one side intersecting the axial direction of the binding portion 7 with respect to the arm part 50.

In addition, when the tip guide part 9R is supported on the main body-side tip guide support portion 97R, the arm support portion 90R is positioned forward along the axial direction of the binding portion 7 relative to the main body-side arm support portion 95 and the screws 95a. Additionally, when the tip guide part 9R is supported on the main body-side tip guide support portion 97R, the arm support portion 90R is positioned on the other side intersecting the axial direction of the binding portion 7 with respect to the arm part 50.

Accordingly, the arm support portion 90L of the tip guide part 9L and the arm support portion 90R of the tip guide part 9R are provided on both sides of the arm part 50, and the arm part 50 is sandwiched between the arm support portion 90L of the tip guide part 9L and the arm support portion 90R of the tip guide part 9R.

In the arm support portion 90L, the screws 90s pass through the hole portions 90La. The screw 90s is an example of a second support portion. The screws 90s passing through the hole portions 90La pass through the hole portions 50a of the arm part 50 and are fastened to the screw hole portions 90Ra of the arm support portion 90R.

Thereby, the arm part 50 is supported via the screws 90s by the arm support portions 90L and 90R in the form of being sandwiched between the arm support portion 90L of the tip guide part 9L and the arm support portion 90R of the tip guide part 9R.

Accordingly, the arm part 50 is supported by the tip guide part 9L via the arm support portion 90L using the screws 90s, at a position forward along the axial direction of the binding portion 7 relative to the main body-side arm support portion 95 and the screws 95a. In addition, the arm part 50 is supported by the tip guide part 9R via the arm support portion 90R using the screws 90s, at a position forward along the axial direction of the binding portion 7 relative to the main body-side arm support portion 95 and the screws 95a.

In addition, when the tip guide part 9L is supported by the main body-side tip guide support portion 97L, the curl guide support portion 91L is positioned forward along the axial direction of the binding portion 7 relative to the main body-side curl guide support portion 96 and the screws 96La. In addition, when the tip guide part 9L is supported by the main body-side tip guide support portion 97L, the curl guide support portion 91L is positioned on one side intersecting the axial direction of the binding portion 7 with respect to the curl guide part 51.

In addition, when the tip guide part 9R is supported by the main body-side tip guide support portion 97R, the curl guide support portion 91R is positioned forward along the axial direction of the binding portion 7 relative to the main body-side curl guide support portion 96 and the screws 96Ra. In addition, when the tip guide part 9R is supported by the main body-side tip guide support portion 97R, the curl guide support portion 91R is positioned on the other side intersecting the axial direction of the binding portion 7 with respect to the curl guide part 51.

Accordingly, the curl guide support portion 91L of the tip guide part 9L and the curl guide support portion 91R of the tip guide part 9R are provided on both sides of the curl guide part 51, and the curl guide part 51 is sandwiched between the curl guide support portion 91L of the tip guide part 9L and the curl guide support portion 91R of the tip guide part 9R.

In the curl guide support portion 91L, the screw 91s passes through the hole portion 91La. The screw 91s is an example of a second support portion. The screw 91s passing through the hole portion 91La passes through the hole portion 51a of the curl guide part 51 and is fastened to the screw hole portion 91Ra of the curl guide support portion 91R.

Thereby, the curl guide part 51 is supported via the screw 91s by the curl guide support portions 91L and 91R in the form of being sandwiched between the curl guide support portion 91L of the tip guide part 9L and the curl guide support portion 91R of the tip guide part 9R.

Accordingly, the curl guide part 51 is supported by the tip guide part 9L via the curl guide support portion 91L using the screw 91s, at a position forward along the axial direction of the binding portion 7 relative to the main body-side curl guide support portion 96 and the screws 96La. In addition, the curl guide part 51 is supported by the tip guide part 9R via the curl guide support portion 91R using the screw 91s, at a position forward along the axial direction of the binding portion 7 relative to the main body-side curl guide support portion 96 and the screws 96Ra. Here, ‘support’ refers to preventing relative movements between the arm part 50 and the main body part 10, between the curl guide part 51 and the main body part 10, and between the arm part 50 and the curl guide part 51, due to translational movement in the X, Y, and Z directions, rotational movement, and the like, and also includes fixing the objects to each other. However, unavoidable movement or movement that does not affect functionality may be included.

### Example of Operational Effects of Reinforcing Bar Binding Machine of Present Embodiment

As described above, the arm part 50 is supported on the main body part 10 by the screws 95a through the main body-side arm support portion 95, and is supported on the tip guide part 9L via the arm support portion 90L by the screws 90s, at a position forward along the axial direction of the binding portion 7 relative to the main body-side arm support portion 95 and the screws 95a. The tip guide part 9L is supported on the main body part 10 by the screws 92Ls through the main body-side tip guide support portion 97L. Thereby, the arm part 50 is supported on the main body part 10 via the tip guide part 9L by the main body-side tip guide support portion 97L, at a part forward along the axial direction of the binding portion 7 relative to the main body-side arm support portion 95.

In addition, the arm part 50 is supported on the tip guide part 9R via the arm support portion 90R by the screws 90s, at a position forward along the axial direction of the binding portion 7 relative to the main body-side arm support portion 95 and the screws 95a. The tip guide part 9R is supported on the main body part 10 by the screws 92Rs through the main body-side tip guide support portion 97R. Thereby, the arm part 50 is supported on the main body part 10 via the tip guide part 9R by the main body-side tip guide support portion 97R, at a part forward along the axial direction of the binding portion 7 relative to the main body-side arm support portion 95.

Accordingly, the arm part 50 constituting the curl forming portion 5 is supported by a plurality of support portions, namely the screws 90s and 95a. Therefore, the arm part 50 can be firmly maintained. In addition, when feeding out the wires W during binding, unintentional movements, such as rattling of the arm part 50, are suppressed, enabling stable binding. In addition, even when the arm part 50 is subjected to impacts due to a drop or collision, damage, such as deformation of the arm part 50, can be suppressed.

In addition, the curl guide part 51 is supported on the main body part 10 by the screws 96La and 96Ra through the main body-side curl guide support portion 96, and is supported on the tip guide part 9L via the curl guide support portion 91L by the screw 91s, at a position forward along the axial direction of the binding portion 7 relative to the main body-side curl guide support portion 96 and the screws 96La and 96Ra. The tip guide part 9L is supported on the main body part 10 by the screws 92Ls through the main body-side tip guide support portion 97L. Thereby, the curl guide part 51 is supported on the main body part 10 via the tip guide part 9L by the main body-side tip guide support portion 97L, at a part forward along the axial direction of the binding portion 7 relative to the main body-side curl guide support portion 96.

In addition, the curl guide part 51 is supported on the tip guide part 9R via the curl guide support portion 91R by the screw 91s, at a position forward along the axial direction of the binding portion 7 relative to the main body-side curl guide support portion 96 and the screws 96La and 96Ra. The tip guide part 9R is supported on the main body part 10 by the screws 92Rs through the main body-side tip guide support portion 97R. Thereby, the curl guide part 51 is supported on the main body part 10 via the tip guide part 9R by the main body-side tip guide support portion 97R, at a part forward along the axial direction of the binding portion 7 relative to the main body-side curl guide support portion 96.

Accordingly, the curl guide part 51 constituting the curl forming portion 5 is supported by a plurality of support portions, namely the screws 91s, 96La, and 96Ra. Therefore, the curl guide part 51 can be firmly maintained. In addition, when receiving the wires W during binding, unintentional movements, such as rattling of the curl guide part 51, are suppressed, enabling stable binding. In addition, even when the curl guide part 51 is subjected to impacts due to a drop or collision, damage, such as deformation of the curl guide part 51, can be suppressed.

In addition, relative displacement between the arm part 50 constituting the curl forming portion 5 and the main body part 10 is regulated by the screws 90s and 95a as support means and the tip guide parts 9L and 9R as regulating means. In addition, relative displacement between the curl guide part 51 constituting the curl forming portion 5 and the main body part 10 is regulated by the screws 91s, 96La, and 96Ra as support means and the tip guide parts 9L and 9R as regulating means. In addition, relative displacement between the arm part 50 and the curl guide part 51 is regulated by the tip guide parts 9L and 9R as regulating means.

Therefore, the arm part 50 and the curl guide part 51 can be firmly maintained. In addition, when feeding out the wires W and receiving the wires W during binding, unintentional movements, such as rattling of the arm part 50 and the curl guide part 51, are suppressed, enabling stable binding. In addition, even when the arm part 50 and the curl guide part 51 are subjected to impacts due to a drop or collision, damage, such as deformation of the arm part 50 and the curl guide part 51, can be suppressed.

In addition, the tip guide part 9L includes the bent portions 93L between the arm support portion 90L and the main body support portion 92L and between the curl guide support portion 91L and the main body support portion 92L, and the tip guide part 9R includes the bent portions 93R between the arm support portion 90R and the main body support portion 92R and between the curl guide support portion 91R and the main body support portion 92R, so that when the arm part 50 and the curl guide part 51 are subjected to impacts due to a drop or collision, the impacts can be absorbed by elastic deformation of the bent portions 93L and 93R.

The tip guide part 9L is supported on the main body portion 10 by the screws 92Ls, on the arm part 50 by the screws 90s, and on the curl guide part 51 by the screw 91s. In addition, the tip guide part 9R is supported on the main body portion 10 by the screws 92Rs, on the arm part 50 by the screws 90s, and on the curl guide part 51 by the screw 91s. The abutting portion 9La of the tip guide part 9L and the abutting portion 9Ra of the tip guide part 9R are likely to wear out due to the abutting of the reinforcing bars S. Therefore, the tip guide parts 9L and 9R are detachably supported on the main body part 10, the arm part 50, and the curl guide part 51 using fastening members such as screws, enabling easy replacement.

### Variations of Reinforcing Bar Binding Machine of Present Embodiment

The tip guide part 9L may be configured to include the abutting portion 9La and the arm support portion 90L without including the curl guide support portion 91L. In addition, the tip guide part 9L may be configured to include the abutting portion 9La and the curl guide support portion 91L without the arm support portion 90L. The same applies to the tip guide part 9R.

In addition, the tip guide parts 9L and 9R may be made of metal or resin. When the tip guide parts 9L and 9R and the arm part 50 are made of metal, the tip guide parts 9L and 9R and the arm part 50 may be supported by welding or the like without considering attachment or detachment. Likewise, when the tip guide parts 9L and 9R and the curl guide part 51 are made of metal, the tip guide parts 9L and 9R and the curl guide part 51 may be supported by welding or the like without considering attachment or detachment. In addition, the tip guide parts 9L and 9R and the arm part 50 may be supported by adhesion or the like without considering attachment or detachment, and the tip guide parts 9L and 9R and the curl guide part 51 may be supported by adhesion or the like without considering attachment or detachment. In addition, the tip guide parts 9L and 9R and the arm part 50 may be supported by rivets, swaging, or the like without considering attachment or detachment, and the tip guide parts 9L and 9R and the curl guide part 51 may be supported by rivets, swaging, or the like without considering attachment or detachment.

In addition, as a form of extending a part of the main body part 10, the arm support portions 90L and 90R may be formed integrally with the main body part 10, and the curl guide support portions 91L and 91R may be formed integrally with the main body part 10.

In the reinforcing bar binding machine 1A, a configuration is known in which the curl guide part 51 is rotatably supported with the main body-side curl guide support portion 96 serving as a fulcrum, and the curl guide part 51 is urged in a predetermined direction by an urging member such as a spring. However, when the diameter of the annular feeding path Ru that wraps around the reinforcing bars S increases, it is preferable for the curl guide part 51 to be supported in order to guide the wires W curled by the arm part 50 to the binding portion 7 while keeping it in contact with the curl guide part 51. In contrast, in a configuration where the curl guide part 51 is urged with a force that does not move the curl guide part 51 when the wires W come into contact, the curl guide part 51 may be configured to be movable. In this case, a shaft or the like that movably supports the curl guide part 51 may be configured to be supported through the tip guide parts 9L and 9R.

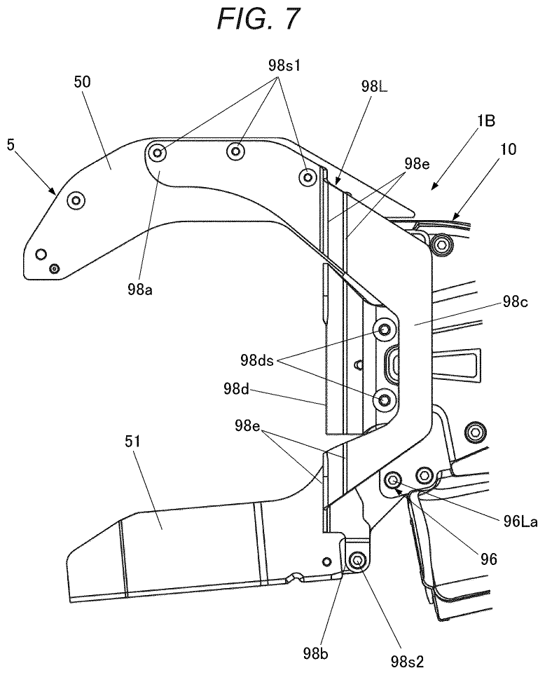

FIG. 7 is a side view of main parts showing another example of the reinforcing bar binding machine of the present embodiment, as seen from a side. A reinforcing bar binding machine 1B includes a support member 98L that regulates the relative displacement between the arm part 50 and the curl guide part 51. Note that a similar support member is also provided on the other side, but the support member on the other side is not shown.

The support member 98L is an example of a regulating means and includes an arm support portion 98a supported on the arm part 50, a curl guide support portion 98b supported on the curl guide part 51, and a connecting portion 98c connecting the arm support portion 98a and the curl guide support portion 98b.

In the support member 98L, the arm support portion 98a is positioned forward along the axial direction of the binding portion 7 relative to the main body-side arm support portion 95 and the screws 95a shown in FIGS. 5A and 5B. Additionally, in the support member 98L, the curl guide support portion 98b is positioned forward along the axial direction of the binding portion 7 relative to the main body-side curl guide support portion 96 and the screws 96La. Additionally, the support member 98L is provided on one side of the reinforcing bar binding machine 1B, and the support member, not shown, is provided on the other side of the reinforcing bar binding machine 1B. Thereby, the arm part 50 is sandwiched between the arm support portions 98a of the pair of support members. Additionally, the curl guide part 51 is sandwiched between the curl guide support portions 98b of the pair of support members. The arm support portion 98a is supported on the arm part 50 by screws 98s1. Additionally, the curl guide support portion 98b is supported on the curl guide part 51 by a screw 98s2. The support location by the screws 98s1 is positioned forward along the axial direction of the binding portion 7 relative to the main body-side arm support portion 95 and the screws 95a shown in FIGS. 5A and 5B. Additionally, the support location by the screw 98s2 is positioned forward along the axial direction of the binding portion 7 relative to the main body-side curl guide support portion 96 and the screws 96La.

The support member 98L includes bent portions 98e between the arm support portion 98a and the connecting portion 98c and between the curl guide support portion 98b and the connecting portion 98c.

The reinforcing bar binding machine 1B includes an abutting portion 98d against which the reinforcing bars S are abutted. The abutting portion 98d is provided between the arm part 50 and the curl guide part 51 and protrudes further forward than the end portion on the front side of the main body portion 10. The abutting portion 98d is supported on the main body part 10 by screws 98ds. In the reinforcing bar binding machine 1B, the support member 98L and the abutting portion 98d are configured as separate components.

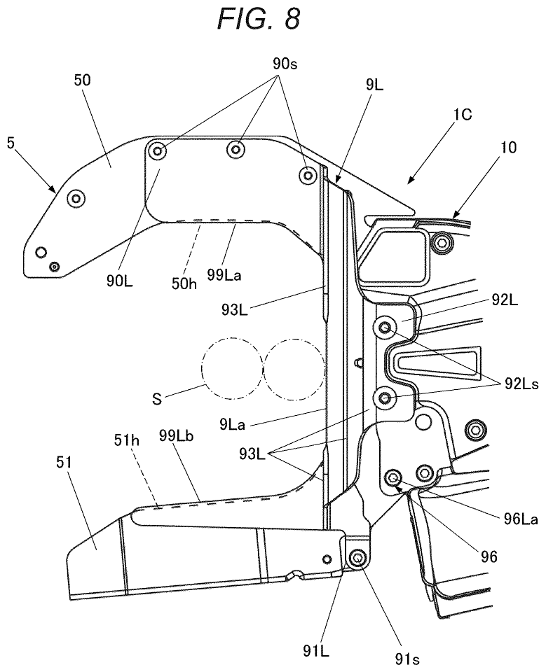

FIG. 8 is a side view of main parts showing still another example of the reinforcing bar binding machine of the present embodiment, as seen from a side. A reinforcing bar binding machine 1C includes a tip guide part 9L (9R) against which the reinforcing bars S are abutted and which supports the curl forming portion 5. In FIG. 8, the tip guide part 9R is not shown.

The tip guide part 9L is an example of a support member and is provided at an end portion on the front side of the main body portion 10, on one side. The tip guide part 9L includes an abutting portion 9La against which the reinforcing bars S are abutted, an arm support portion 90L supported on the arm part 50, a curl guide support portion 91L supported on the curl guide part 51, and a main body support portion 92L supported on the main body part 10.

The abutting portion 9La is provided between the arm part 50 and the curl guide part 51 and protrudes further forward than the end portion on the front side of the main body portion 10.

The arm support portion 90L is an example of a first supported portion and extends forward from the abutting portion 9La along the arm part 50. The arm support portion 90L is supported on the arm part 50 by the screws 90s. The arm support portion 90L includes a contact portion 99La with which the reinforcing bars S can come into contact. The contact portion 99La protrudes toward the curl guide part 51 side with respect to an opposing surface 50h of the arm part 50 facing the curl guide part 51. Note that the contact portion 99La may be flush with the opposing surface 50h.

The curl guide support portion 91L is an example of a first supported portion and extends forward from the abutting portion 9La along the curl guide part 51. The curl guide support portion 91L is supported on the curl guide part 51 by the screw 91s. The curl guide support portion 91L includes a contact portion 99Lb with which the reinforcing bars S can come into contact. The contact portion 99Lb extends forward from the abutting portion 9La along the curl guide part 51, and protrudes toward the arm part 50 side with respect to an opposing surface 51h of the curl guide part 51 facing the arm part 50. Note that the contact portion 99Lb may be flush with the opposing surface 51h.

The main body support portion 92L is an example of a second supported portion and connects the arm support portion 90L and the curl guide support portion 91L. The main body support portion 92L is supported on the main body part 10 by screws 92Ls.

The tip guide part 9L includes bent portions 93L between the arm support portion 90L and the main body support portion 92L and between the curl guide support portion 91L and the main body support portion 92L. The bent portions 93L are configured by providing bent portions, curved portions, or the like, in which a step is formed, between the arm support portion 90L and the main body support portion 92L and between the curl guide support portion 91L and the main body support portion 92L.

In the reinforcing bar binding machine 1C, when the reinforcing bars S are inserted between the arm part 50 and the curl guide part 51, the reinforcing bars S may come into contact with the contact portions 99La and 99Lb. By providing the contact portions 99La and 99Lb, the reinforcing bars S are suppressed from coming into contact with the arm part 50 and the curl guide part 51. In addition, when the contact portions 99La and 99Lb are worn as a result of the reinforcing bars S coming into contact, it is sufficient to replace the tip guide part 9L, which can suppress wear of the arm part 50 and the curl guide part 51. Either the contact portion 99La or the contact portion 99Lb may be provided.

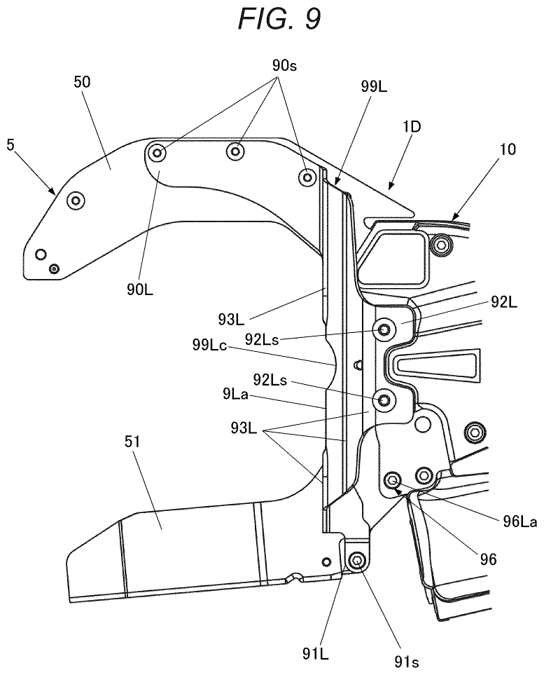

FIG. 9 is a side view of main parts showing yet another example of the reinforcing bar binding machine of the present embodiment, as seen from a side.

In a reinforcing bar binding machine 1D, a tip guide part 99L includes an escape portion 99Lc. The escape portion 99Lc is a space for increasing a shortest distance dimension between the tip guides on both sides so that when a twisted portion of the wire W twisted by the binding portion 7 separates from the binding portion 7, the wire is not caught on the tip guide part 99L, more specifically, an end portion of the wire, which is farther than the twisted portion, is not caught on the tip guide part 99L and escapes smoothly. The escape portion 99Lc may also be provided on the tip guide part (not shown) provided on the other side, and may be applied to all of the above-described embodiments. In addition, although the escape portion 99Lc is shown as an arc-shaped gap, the escape portion may be formed by increasing a distance between the contact portions of the tip guides provided on both sides.

Note that the arm part 50 may be attached as a separate body to the main body part 10, or may be provided integrally with the main body part 10. For example, the arm part 50 may extend from the main body part 10.

As described above, an aspect of the present disclosure is a binding machine configured to wind a wire around a to-be-bound object, including: a main body part; an arm part attached to the main body part and configured to curl the wire; a curl guide part attached to the main body part and configured to guide the wire curled by the arm part to a binding portion; and a regulating member configured to regulate relative displacement between the arm part and the curl guide part.

In addition, another aspect of the present disclosure is a binding machine configured to wind a wire around a to-be-bound object, including: a main body part; an arm part attached to the main body part and configured to curl the wire; a curl guide part attached to the main body part; and a support member configured to support at least one of the main body part, the arm part, and the curl guide part.

In the present disclosure, the relative displacement between the arm part and the curl guide part can be regulated. In addition, in the present disclosure, the arm part and the curl guide part can be firmly maintained. In addition, when feeding or receiving the wire during binding, unintentional movements, such as rattling of the arm part and the curl guide part, are suppressed, enabling stable binding. Further, even when the arm part or curl guide part is subjected to impacts due to a drop or collision, damage, such as deformation of the curl forming portion, can be suppressed.

According to the present disclosure, it is possible to provide a binding machine configured to be able to firmly maintain a curl forming portion.

What is claimed is:

1. A binding machine configured to wind a wire around a to-be-bound object, comprising:
a main body part;
an arm part attached to the main body part and configured to curl the wire;
a curl guide part attached to the main body part and configured to guide the wire curled by the arm part to a binding portion; and
a regulating member configured to regulate relative displacement between the arm part and the curl guide part.

2. The binding machine according to claim 1, wherein the regulating member is a member different from the main body part, the arm part, and the curl guide part.

3. The binding machine according to claim 1, wherein the regulating member is configured to regulate relative displacement among the arm part, the curl guide part, and the main body part.

4. A binding machine configured to wind a wire around a to-be-bound object, comprising:
a main body part;
an arm part attached to the main body part and configured to curl the wire;
a curl guide part attached to the main body part; and
a support member configured to support at least one of the main body part, the arm part, and the curl guide part.

5. The binding machine according to claim 4, wherein the arm part and the curl guide part are each supported on the main body part by the support member.

6. The binding machine according to claim 5, wherein the arm part, the curl guide part, and the main body part are each supported by the support member.

7. The binding machine according to claim 4, wherein the support member comprises a bent portion.

8. The binding machine according to claim 4, wherein the support member comprises a contact portion protruding further toward the curl guide part than the arm part, or protruding further toward the arm part than the curl guide part.

9. The binding machine according to claim 4, wherein the support member extends with a support location, serving as a base end, between the main body part and the arm part or the curl guide part, and tapers from the base end toward a tip in an extension direction of the arm part or the curl guide part.

10. The binding machine according to claim 4, wherein the support member extends with a support location, serving as a base end, between the main body part and the arm part or the curl guide part and comprises a tip in an extension direction of the arm part or the curl guide part from the base end, and the base end is thicker than the tip.

11. The binding machine according to claim 4, wherein a support location between the support member and the arm part or the curl guide part is provided at a location different from a path of the wire.

12. The binding machine according to claim 4, wherein the support member is provided on both sides of the arm part or the curl guide part.

13. The binding machine according to claim 4, wherein the support member comprises an abutting portion against which the to-be-bound object is to be abutted.

14. The binding machine according to claim 4, wherein the support member comprises an escape portion with which the wound wire does not interfere.
